(19) United States
(12) Patent Application Publication
(10) Pub. No.: US 2018/0053058 A1
(43) Pub. Date: Feb. 22, 2018

(54) DISPLAY APPARATUS

(71) Applicant: DENSO CORPORATION, Kariya-city, Aichi-pref. (JP)

(72) Inventors: Toshiyuki KONISHI, Kariya-city (JP); Tetsuya TOMARU, Kariya-city (JP); Yoshiyuki TSUDA, Kariya-city (JP)

(21) Appl. No.: 15/556,771

(22) PCT Filed: Mar. 24, 2016
(86) PCT No.: PCT/JP2016/001716

§ 371 Date: Sep. 8, 2017

(30) Foreign Application Priority Data
Apr. 10, 2015 (JP) 2015-080998

(51) Int. Cl. G06K 9/00; G02F 1/133; H04N 7/18; G01S 13/86

(52) U.S. Cl. CPC G06K 9/00791; G01S 13/867; H04N 7/18; G02F 1/133

(57) ABSTRACT

A display apparatus includes: a camera that captures surroundings of a vehicle and generates a capture image; an image processing circuit that is supplied with the capture image as successive image data, performs predetermined image processing, and outputs an output image including display-use image data; and a liquid crystal panel that displays the output image as a motion picture. The display apparatus further includes: a traveling state detector that detects a signal comparable to a traveling state of the vehicle; and a correction section provided in the image processing circuit. The correction section performs residual image correction to suppress occurrence of a residual image in the output image due to a decreased response rate of the liquid crystal panel, in accordance with a traveling state of the vehicle acquired by the traveling state detector when a temperature of the liquid crystal panel is lower than a predetermined temperature.

### CROSS REFERENCE TO RELATED APPLICATION

The present application is based on Japanese Patent Application No. 2015-80998 filed on Apr. 10, 2015, the disclosure of which is incorporated herein by reference.

### TECHNICAL FIELD

The present disclosure relates to a display apparatus that displays a capture image captured by a camera on a display unit.

### BACKGROUND ART

Patent Literature 1 describes a conventional display apparatus that includes a liquid crystal panel and is mounted on a battery forklift so as to be used under a low-temperature environment. The liquid crystal panel previously stores a plurality of image data. The respective image data needed for cargo handling operations are selectively refreshed to be displayed in the liquid crystal panel in response to switch manipulation by an operator.

A response rate of the liquid crystal display greatly decreases when the ambient temperature for the liquid crystal panel goes below a predetermined temperature. To solve this, the liquid crystal panel is under control to be heated with a heater resistor; this prevents a decrease in the response rate (screen refresh rate) for the liquid crystal display due to low temperature. The liquid crystal density is controlled to increase with decreasing outdoor air temperature based on a main density of the liquid crystal panel so as to appropriately adjust the density of characters displayed on the liquid crystal panel.

### PRIOR ART LITERATURES

### Patent Literature

Patent Literature 1: JP 2010-058713 A

### SUMMARY OF INVENTION

Patent Literature 1 merely prevents a decrease in the screen refresh rate of image data already stored in the liquid crystal panel or merely adjusts the character density in relation to the ambient temperature.

In contrast, for example, a display apparatus (electron mirror) allows a liquid crystal panel to display images around a vehicle as a motion picture when images are captured by a camera provided outside the vehicle. In this case, a response rate of image display decreases with decreasing temperature of the liquid crystal panel under a low-temperature environment. A residual image occurs in the motion picture displayed on the liquid crystal panel and causes the image to be less visible.

The temperature greatly affects a level of residual image occurrence. A detected temperature is often accompanied by error when a residual image is suppressed (corrected) based on the temperature directly or indirectly detected from the liquid crystal panel. The error causes insufficient correction or excessive correction.

It is an object of the present disclosure to provide a display apparatus capable of preventing display quality from degrading under a low-temperature environment when an image captured by a camera mounted on a vehicle is displayed as a motion picture on a liquid crystal panel.

According to an example of the present disclosure, a display apparatus is provided to include: a camera that captures surroundings of a vehicle and generates a capture image; an image processing circuit that is supplied with the capture image as successive image data, performs predetermined image processing, and outputs an output image including display-use image data; and a liquid crystal panel that displays the output image as a motion picture. The display apparatus further includes: a traveling state detector that detects a signal comparable to a traveling state of the vehicle; and a correction section provided in the image processing circuit. The correction section performs residual image correction to suppress occurrence of a residual image in the output image due to a decreased response rate of the liquid crystal panel, in accordance with a traveling state of the vehicle acquired by the traveling state detector when a temperature of the liquid crystal panel is lower than a predetermined temperature.

A response rate of a liquid crystal panel decreases and an output image causes a residual image under a low-temperature environment where the temperature of the liquid crystal panel is lower than a predetermined temperature. Normally, the display of the liquid crystal panel is therefore corrected based on temperature conditions. However, the temperature detection is subject to an error. Appropriate correction may be unavailable from residual image correction based on the detected temperature of the liquid crystal panel. Types of residual image occurrence largely differ depending on capture targets that vary with traveling states of the vehicle.

In the present example, a correction section performs the residual image correction based on traveling states of the vehicle when a residual image occurs on the liquid crystal panel under the low-temperature environment. The correction is available in accordance with types of residual image occurrence depending on traveling states and is capable of preventing the display quality from degrading under the low-temperature environment. This case can suppress an influence of insufficient correction or excessive correction due to temperature detection errors.

### BRIEF DESCRIPTION OF DRAWINGS

The above and other objects, features and advantages of the present disclosure will become more apparent from the following detailed description made with reference to the accompanying drawings. In the drawings:

FIG. 1 is a block diagram illustrating an overall configuration of a display apparatus according to a first embodiment;

FIG. 2 is an explanatory diagram illustrating a rendering circuit according to the first embodiment;

FIG. 3 is a flowchart illustrating an outline of residual image correction according to the first embodiment;

FIG. 4 is an example illustrating a displayed image of a captured oncoming vehicle;

FIG. 5A is an explanatory diagram illustrating a display image of a displayed image processed by residual image correction according to the first embodiment;

FIG. 5B is an explanatory diagram illustrating a display image of a displayed image not processed by residual image correction according to the first embodiment;

FIG. 6 is an explanatory diagram illustrating a rendering circuit according to a second embodiment; and

FIG. 7 is a block diagram illustrating an overall configuration of a display apparatus according to a third embodiment.

### EMBODIMENTS FOR CARRYING OUT INVENTION

The following describes a plurality of embodiments of the present disclosure with reference to the accompanying drawings. When each embodiment describes only part of the configuration, the other parts of the configuration may conform to the description in the other preceding embodiments.

### First Embodiment

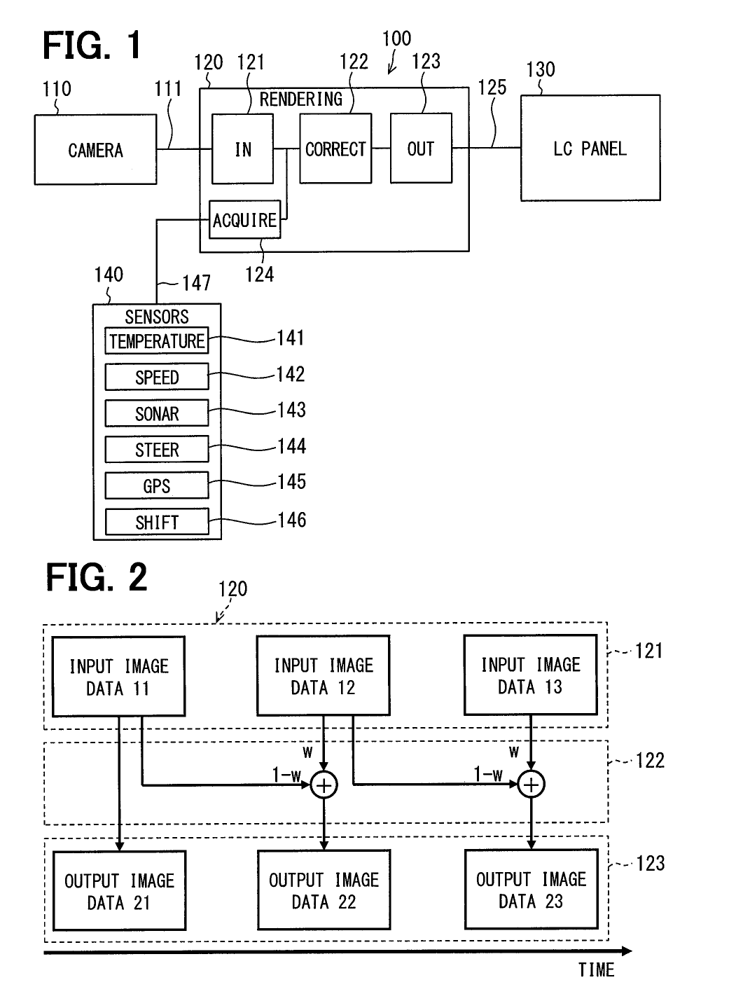

A display apparatus 100 according to a first embodiment will be described with reference to FIGS. 1 through 5B. The display apparatus 100 according to the embodiment is applicable to vehicles. According to the embodiment, the display apparatus 100 is mounted on a vehicle, for example. The vehicle is referred to as a host vehicle or a subject vehicle. The display apparatus 100 uses cameras 110 in place of a conventional optical mirror (door mirror or rear view mirror) to capture an area diagonally backward or backward of the vehicle. A captured image is displayed on a liquid crystal display 130 provided in a vehicle compartment. As in FIGS. 1 and 2, the display apparatus 100 includes the cameras 110, a rendering circuit 120, a liquid crystal display 130, and a sensor group 140.

The cameras 110 capture scenes (surroundings) at areas diagonally backward and backward of the vehicle, for example, and are provided at right and left surfaces and the rear surface of the vehicle. Two cameras 110 are provided here, one for a front door corresponding to the driver's seat (right of the vehicle) and the other for a front door corresponding to the passenger seat (left of the vehicle) so as to correspond to conventional door mirror positions on a right-hand drive vehicle, for example. The two cameras 110 right and left each capture areas diagonally backward of the vehicle correspondingly to the driver's seat and the passenger seat. Another camera 110 is provided at the horizontal center of a rear bumper on the vehicle. The rear camera 110 captures an area backward of the vehicle. These cameras 110 basically have the same function.

The cameras 110 each include a wide-angle lens (fisheye lens). The two cameras 110 can capture a wide range of scenes including (i) part of the host vehicle (part of a lateral surface of the vehicle) and (ii) areas diagonally backward of the vehicle. Another camera 110 can capture scenes behind the vehicle. The cameras 110 each generate a capture image and outputs the capture image to the rendering circuit 120 via a signal line 111 to be described later.

The rendering circuit 120 applies predetermined image processing to a capture image (video signal) output from the cameras 110 and is provided as an image processing circuit 120 (also referred to as an image processing unit or an image processor) that performs residual image correction to suppress occurrence of a residual image on the liquid crystal display 130 to be described later. The rendering circuit 120 is provided inside an instrument panel in front of the driver's seat, for example.

The predetermined image processing performed by the rendering circuit 120 includes correction of a distorted image captured by the wide-angle lens or point-of-view conversion (mirror inversion in this example) to produce a capture image as if it were reflecting off an ordinary door mirror (optical mirror), for example. The residual image correction performed by the rendering circuit 120 suppresses a residual image resulting from a motion picture displayed on the liquid crystal display 130 under low-temperature environment where the temperature of the liquid crystal display is lower than a predetermined temperature. The detail will be described later.

The rendering circuit 120 includes an input section 121, a correction section 122, an output section 123, and an acquisition section 124. The rendering circuit 120 outputs an output image to the liquid crystal display 130 via a signal line 125 after the above-mentioned predetermined processing and/or the residual image correction is applied to an image as the output image.

The input section 121 chronologically inputs capture images captured by the cameras 110 as successive image data (hereinafter referred to as input image data). The present embodiment represents the input image data (FIG. 2) as the input image data 11 through 13 corresponding to three frames, for convenience sake. The input image data 11 through 13 include a predetermined number of images (frames) per predetermined time. The input image data 11 through 13 here includes 30 frames per second, for example.

The correction section 122 chronologically performs the residual image correction on the input image data 11 through 13 supplied from the input section 121 in order to suppress occurrence of a residual image in the liquid crystal display 130 based on the temperature of the liquid crystal display 130 and a vehicle traveling state acquired from the sensor group 140 to be described later. The correction section 122 outputs data processed by the residual image correction to the output section 123.

The output section 123 chronologically outputs data corrected by the correction section 122 to the liquid crystal display 130. The data is output as an output image including display-use image data (hereinafter referred to as output image data). The present embodiment represents the output image data (FIG. 2) as the output image data 21 through 23 corresponding to three frames, for convenience sake. The output image data 21 through 23 include the same number of frames as the input image data 11 through 13.

The acquisition section 124 acquires various signals output from the sensor group 140 (to be described later) as characteristic values. The acquisition section 124 outputs the acquired characteristic values to the correction section 122.

The liquid crystal display 130 is also referred to as a liquid crystal panel and displays an output image output from the rendering circuit 120. A digital image is used to display the output image as a motion picture to a driver. The liquid crystal display 130 is provided at a position on an instrument panel so that a driver can easily view the liquid crystal display 130, for example. The liquid crystal display 130 is available as a TFT (Thin Film Transistor) liquid crystal display using thin-film transistors, for example.

A display area of the liquid crystal display 130 is divided correspondingly to a plurality of the cameras 110 to be used, if available, to display a plurality of output images. While the vehicle is traveling, the right side of the liquid crystal display 130 displays an image at an area diagonally right backward of the vehicle and the left side of the liquid crystal display 130 displays an image at an area diagonally left backward of the vehicle, for example. While the vehicle is traveling backward, images at an area diagonally right backward and an area diagonally left backward of the vehicle are changed to an image behind the vehicle, which is then displayed.

The sensor group 140 includes a plurality of sensors 141 through 146. The sensors 141 through 146 detect various detection signals that are then output to the correction section 122 via a signal line 147.

The sensors 141 through 146 here correspond to a temperature sensor 141, a vehicle speed sensor 142, a sonar 143, a steering angle sensor 144, a GPS receiver 145, and a shift position sensor 146. Of the sensors 141 through 146, the vehicle speed sensor 142, the sonar 143, the steering angle sensor 144, the GPS receiver 145, and the shift position sensor 146 are also referred to as a travel state detector or a travel state detection unit.

The temperature sensor 141 directly or indirectly detects a temperature signal corresponding to a liquid crystal temperature in the liquid crystal display 130. The temperature sensor 141 is provided near the liquid crystal of the liquid crystal display 130 to directly detect the liquid crystal temperature signal, for example. The temperature sensor 141 may indirectly detect the liquid crystal temperature by using an in-vehicle temperature sensor that detects an in-vehicle temperature signal corresponding to a vehicle compartment temperature in a vehicular air conditioner, for example.

The vehicle speed sensor 142 is provided for a crankshaft of a vehicle engine, for example, and detects a vehicle speed signal corresponding to a vehicle speed during traveling.

The sonar 143 is provided at four external corners of the vehicle, for example, and detects object signals corresponding to objects around a host vehicle. Objects around the host vehicle include an oncoming vehicle, a parallel running vehicle, a soundproof exterior wall on an expressway, a white line on a road, and a utility pole, for example.

The steering angle sensor 144 is provided for a steering shaft and detects steering angle signals corresponding to an orientation of steering during vehicle turning and a steering angle (manipulation angle) with reference to the neutral position. The vehicle turning mainly occurs when the vehicle turns to the right or left at an intersection, turns along a roundabout, or travels (turns) along a loose curve.

The GPS receiver 145 is provided as an antenna that receives GPS signals corresponding to a host vehicle position, roads, intersections, and traffic lights around the host vehicle represented on a map generated from an artificial satellite in a GPS system (satellite positioning system).

The shift position sensor 146 detects a shift signal corresponding to a combination position of gears in a transmission. The shift signal includes a D (drive) signal representing normal travel and an R (reverse) signal representing backward travel.

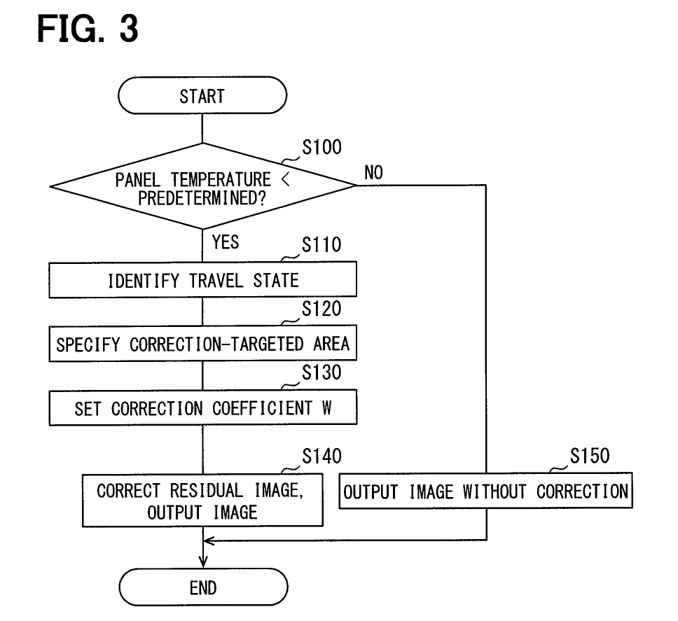

The description below explains operation of the display apparatus 100 configured as above mainly with reference to FIGS. 2 and 3.

When the display apparatus 100 operates, the cameras 110 capture scenes at areas diagonally backward right, an area diagonally backward left, and an area backward of the vehicle, generates a capture image, and outputs the capture image to the rendering circuit 120.

Basically, the rendering circuit 120 performs the above-mentioned specified image processing on a capture image and outputs the processed capture image as an output image to the liquid crystal display 130. The liquid crystal display 130 displays the output image to a driver. The liquid crystal display 130 displays images on the area diagonally backward right and the area diagonally backward left of the vehicle during normal traveling or displays an image behind the vehicle during backward traveling.

A response rate of the liquid crystal display 130 decreases to cause a residual image in the output image when the temperature (liquid crystal temperature) of the liquid crystal display 130 is lower than a predetermined temperature in winter, for example. Decreasing the temperature of the liquid crystal display 130 increases occurrences of a residual image.

A residual image occurs in an output image as follows. The rendering circuit 120 sequentially outputs the input image data 11 through 13 from the input section 121 to the output section 123 to generate the output image data 21 through 23. Meanwhile, a situation to be described below occurs to continuously generate unnatural overlaps in a motion picture displayed on the liquid crystal display 130. The residual image greatly degrades the visibility for the driver.

The current frame is overlapped by a delayed image corresponding to a first-previous frame that is a frame previous to the current frame as the time elapses. An insufficient image results from a delay in starting the image corresponding to the current frame. Under this situation, the insufficient image for the current frame is combined with the delayed image for the first-previous frame to cause a residual image to be displayed (visually observed) as if it were continuously moving on the display screen as the time elapses (FIG. 5B).

According to the embodiment, the correction section 122 performs residual image correction depending on traveling states of the vehicle when the temperature of the liquid crystal display 130 is lower than a predetermined temperature, namely, the liquid crystal display 130 is placed under a low-temperature environment.

The description below explains the essentials of the residual image correction performed by the rendering circuit 120 (correction section 122) with reference to a flowchart in FIG. 3. It is noted that a flowchart described in the present application includes sections (also referred to as steps), each of which is represented, for instance, as S100. Further, each section can be divided into several sub-sections while several sections can be combined into a single section. Furthermore, each of thus configured sections can be also referred to as a device, a module, or a specific name; for instance, a detection section may be referred to as a detection device, a detection module, or detector. Each or any combination of sections explained in the above can be achieved as (i) a software section in combination with a hardware unit (e.g., computer) or (ii) a hardware section (e.g., integrated circuit, hard-wired logic circuit), including or not including a function of a related apparatus; furthermore, the hardware section may be constructed inside of a microcomputer.

At S100 in FIG. 3, the correction section 122 determines whether the temperature of the liquid crystal display 130 is lower than a predetermined temperature, based on a temperature signal detected by the temperature sensor 141.

If S100 is determined affirmatively, the correction section 122 proceeds to S110 and identifies a traveling state of the vehicle based on various detection signals acquired from the various sensors 142 through 146 in the sensor group 140. The traveling state of the vehicle is configured as follows.

Namely, the traveling state of the vehicle is configured during high-speed traveling on the expressway to signify that an oncoming vehicle exists, the host vehicle overtakes a parallel running vehicle, and a soundproof exterior wall is provided for an expressway. The correction section 122 identifies whether an oncoming vehicle exists, based on a vehicle speed signal and an object image on the oncoming lane side, identifies whether the host vehicle overtakes a parallel running vehicle, based on a vehicle speed signal and an object image on the cruising lane side, and identifies whether a soundproof exterior wall is provided, based on a vehicle speed signal and a continuous object signal detected by the sonar 143.

The traveling state of the vehicle is configured during low-speed traveling in an urban area to signify a right or left turn at an intersection, approach to an intersection, brief stop to wait at the traffic light, and turning travel on a roundabout. The correction section 122 identifies the right or left turn, brief stop, and turning travel on a roundabout based on a vehicle speed signal and a steering angle signal, and identifies approach to an intersection, based on a GPS signal.

The traveling state of the vehicle is configured during parking and backward traveling to signify parallel parking, backward parking, and backward exit from forward parking. The correction section 122 identifies parallel parking, backward parking, and backward exit based on a shift signal and a steering angle signal.

At S120, the correction section 122 specifies a correction-targeted area to which residual image correction is applied in the output image. Output images (capture images) each include characteristics (scene situations) depending on traveling states of the vehicle and are subject to a display issue based on the characteristics. As a solution for the display issue, the correction-targeted area is provided to determine (limit) part of an output image where the residual image correction needs to be performed.

During high-speed traveling, the correction is basically targeted at a display object causing a long travel distance and increases a correction degree (correction coefficient w) to be described later. Though targeted at the correction, a distant point (vanishing point) in an image has a small influence on residual image occurrence and is given a small correction degree.

During high-speed traveling, an oncoming vehicle, if any, causes a long travel distance and easily generates a residual image. The oncoming vehicle is therefore assumed to be a correction object (correction-targeted area) and a correction degree is increased as will be described later. In this case, it is effective to correct the image quality of a capture image before the residual image correction in order to facilitate the residual image correction. The image quality correction will be described in the third embodiment below.

Suppose the host vehicle overtakes a parallel running vehicle during high-speed traveling. The parallel running vehicle causes a short travel distance and an excessive correction results if the residual image correction is performed similarly to the above-mentioned oncoming vehicle. Though targeted at the correction, the parallel running vehicle is given a small correction degree to be described later. In this case, it is favorable to perform time correction to restore the original state after the residual image correction is performed in order to suppress a noise in an output image due to the residual image correction. The time correction will be described in the fourth embodiment below.

During high-speed traveling, an exterior wall is near to the vehicle, causes a long travel distance in an output image, and easily causes a residual image (to display a pole as if it vanish). The exterior wall is therefore targeted at the correction. Particularly, the residual image correction allows an exterior wall constructed in gray to be adjusted to the luminance that provides the liquid crystal display 130 with a high response rate. The luminance correction (image quality correction) will be described in the third embodiment below.

During low-speed traveling, the right or left turn causes large motion at the outside of the host vehicle, easily generating a residual image. The outside is therefore targeted at the correction and is given a large correction degree to be described later. The inside of the host vehicle causes small motion and an excessive correction results if the residual image correction is performed similarly to the above-mentioned outside. Though targeted at the correction, the inside is given a small correction degree to be described later.

During low-speed traveling, approach to an intersection requires attention to the movement in a vanishing point direction and the movement in an intersecting direction. Particularly, a residual image is easily generated on a display object in the intersecting direction. An area in the intersecting direction is therefore targeted at the correction and is given a large correction degree to be described later.

During low-speed traveling, the brief stop eliminates movement from a background. A moving display object easily generates a residual image. The residual image correction is therefore performed by using an area corresponding to the end of the display screen as a correction target so that residual image correction can be applied to a moving object that newly enters a capture region. The residual image correction is not applied to the background.

During low-speed traveling, the turning travel on a roundabout most often relates to parallel running vehicles that turn normally. The residual image correction to be described later, if performed, may result in excessive correction. Though targeted at the correction, the parallel running vehicle is given a small correction degree to be described later. The vanishing point moves as often as the number of turns. Though targeted at the correction, the vanishing point is given a small correction degree to be described later.

During parking and backward traveling, the parallel parking allows one lateral side of the host vehicle to correspond to a distant scene and the other lateral side to correspond to a nearby scene. An image also moves right and left. Image movement needs to be suppressed near the vanishing point. The backward parking and the backward exit reverse the movement direction of the normal travel, proceed at a low speed, and require fully turning a steering wheel. An output image moves right and left. Intersecting objects easily cause a residual image. The entire output image is therefore targeted at correction and is corrected based on the temperature during the parallel parking and the backward parking. The entire output image is targeted at correction and is given a large correction degree to be described later during the backward exit.

At S130, the correction section 122 sets correction coefficient w for the residual image correction based on various traveling states. Namely, the correction section 122 sets (changes) correction coefficient w for each correction-targeted area based on various traveling states and corrects a residual image. Correction coefficient w is provided as a weight coefficient to specify a correction degree in the residual image correction. Correction coefficient w uses a numeric value equal to or greater than 1.

As above, the correction section 122 increases or decreases correction coefficient w based on various traveling states. As above, the correction section 122 specifies correction coefficient w based on object characteristics (such as long or short travel distance, oncoming vehicle, parallel running vehicle, image luminance, and color) in a capture image. Increasing correction coefficient w intensely corrects a residual image. Decreasing correction coefficient w decreases the correction degree for a residual image and allows the residual image to hardly disappear. Excessively increasing correction coefficient w generates a residual image whose brightness and darkness are reversed.

At S140, the correction section 122 performs the residual image correction by using correction coefficient w specified as above. The correction section 122 allows the output section 123 to output the corrected output image data 21 through 23 to the liquid crystal display 130.

FIG. 2 illustrates an overview of the specific residual image correction. The input image data 11 is provided as the output image data 21 as is. The input image data 12 is assumed to be the current frame. The input image data 11 is assumed to be the first-previous frame. The input image data 12 is multiplied by correction coefficient w to generate intensified image data to sharply render image data for the current frame. The input image data 11 for the first-previous frame is multiplied by (1−w) to nullify a residual image due to the input image data for the first-previous frame and generate image data whose contrasting densities are reversed. Both image data are combined to generate the output image data 22.

Subsequently, the input image data 13 and 12 are likewise used to generate the output image data 23. Image data for the current frame and image data for the first-previous frame are used to sequentially repeat the residual image correction for the current image data. The gradation of the combined output image data may exceed a specified value (e.g., 255 in 8 bits). In such a case, the maximum value (255) is used as a gradation value.

If S100 is determined negatively, the correction section 122 proceeds to S150 and outputs an image without the residual image correction. Correction coefficient w at S140 above is set to “1” when the residual image correction is not performed. Namely, setting correction coefficient w to “1” places 0 in the data weighted with (1−w) for the first-previous frame. Data corresponding to the input image 12 weighted with w for the current frame remains the input image data 12 and is output as the output image data 22.

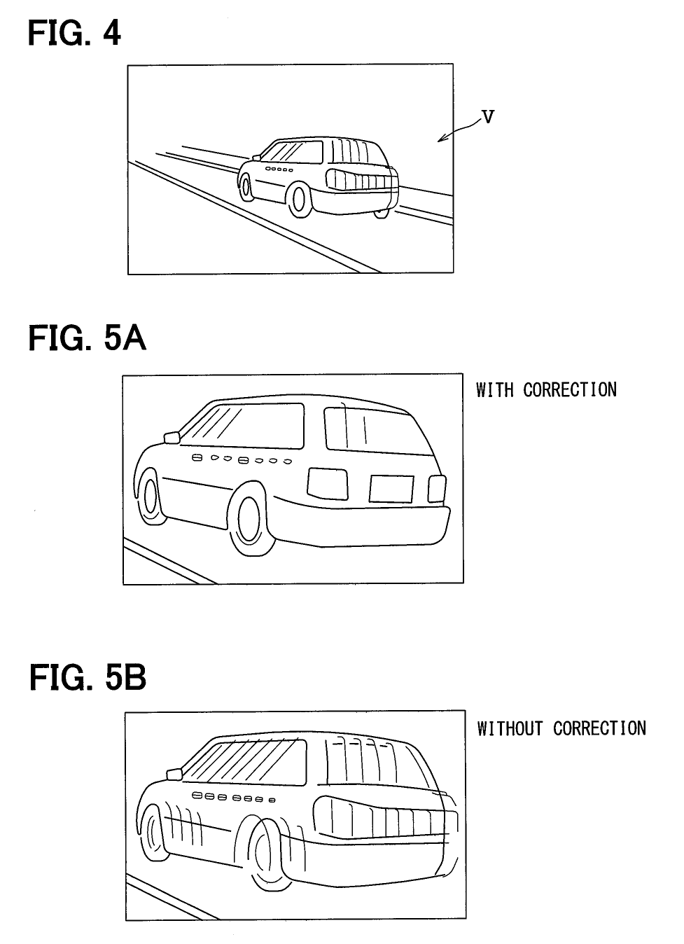

FIGS. 4, 5A, and 5B illustrate output images concerning the residual image correction. FIG. 4 is an image captured by the camera 110 provided for the right door of the host vehicle under low-temperature environment and illustrates a situation where an oncoming vehicle passes through the host vehicle right backward. As in FIG. 5B, the residual image correction is not performed and many residual images occur mainly at the A pillar, the C pillar, door handles, front and rear tires, rear fog lamps. However, the above-mentioned residual image correction is performed to verity that occurrence of residual images is greatly suppressed as in FIG. 5A.

As above, according to the present embodiment, the correction section 122 of the rendering circuit 120 performs the residual image correction when the temperature of the liquid crystal display 130 is lower than a predetermined temperature depending on traveling states of the vehicle acquired from the sensor group 140 in order to prevent an output image from causing a residual image due to a decreased response rate of the liquid crystal display 130.

The response rate of the liquid crystal display 130 decreases and the output image causes a residual image under a low-temperature environment where the temperature of the liquid crystal display 130 is lower than a predetermined temperature. Normally, the display of the liquid crystal display 130 is therefore corrected based on temperature conditions. However, the temperature detection is subject to an error. Appropriate correction may be unavailable from the residual image correction based on the detected temperature of the liquid crystal display 130. Types of residual image occurrence largely differ depending on capture targets that vary with traveling states of the vehicle.

The present embodiment therefore performs the residual image correction based on traveling states of the vehicle when a residual image occurs on the liquid crystal display 130 under the low-temperature environment. The correction is available in accordance with types of residual image occurrence depending on traveling states and is capable of preventing the display quality from degrading under the low-temperature environment. In this case, it is possible to suppress an influence of insufficient correction or excessive correction due to temperature detection errors.

The correction section 122 specifies an area targeted at the residual image correction in the capture image and performs the residual image correction by using correction coefficient w that differs from area to area. As above, there are various capture images around the vehicle such that one capture image moves, another does not move, still another is largely captured in the image, and yet another is small captured. A residual image easily occurs on a moving or large capture object and hardly occurs on a motionless or small capture object. Unnecessary correction can be suppressed and the effective residual image correction is available by previously specifying a capture object easily causing a residual image and performing the residual image correction (specifying an area and setting correction coefficient w) on the capture object.

Correction coefficient w is specified based on characteristics of an object in the capture image such as long or short travel distance, oncoming vehicle, parallel running vehicle, image luminance, and color. The appropriate residual image correction is thereby available in accordance with objects.

The sensor group 140 (traveling state detector) uses the vehicle speed sensor 142, the sonar 143, the steering angle sensor 144, the GPS receiver 145, and the shift position sensor 146. Various traveling states of the vehicle can be thereby appropriately detected and the residual image correction can reflect the detected traveling state.

The residual image correction specifies correction coefficient w for correction in accordance with traveling states of the vehicle. Correction coefficient w is used to combine data out of the input image data 11 through 13, namely, combine data for the current frame by increasing an output level with data for the first-previous frame by decreasing an output level. Output image data for the current frame is formed and is output as an output image. Correction coefficient w can be thereby used to form and output the appropriate output image data 21 through 23 that suppress occurrence of a residual image.

Correction coefficient w is provided as a numeric value equal to or greater than 1. The correction section 122 multiplies the input image data for the current frame by correction coefficient w to increase the output level of the current frame and multiplies the input image data for the first-previous frame by (1−w) to decrease the output level of the first-previous frame. It is possible to perform the specific correction using correction coefficient w.

### Second Embodiment

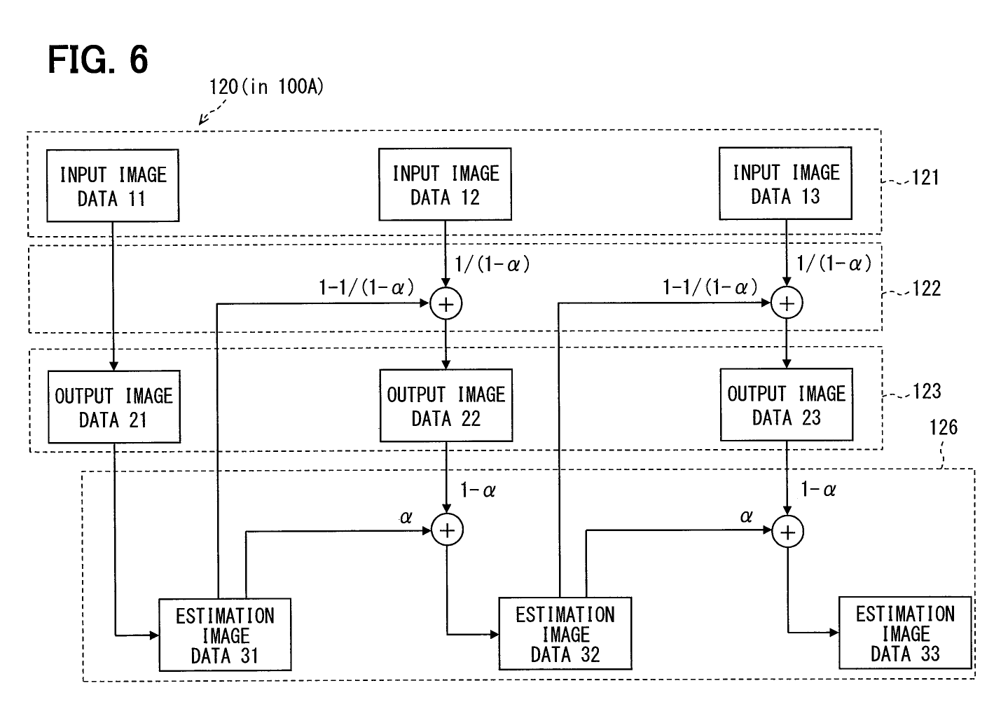

FIG. 6 illustrates a display apparatus 100A according to the second embodiment. The display apparatus 100A according to the second embodiment is provided by adding an estimation image generation section 126 to the rendering circuit 120 in the display apparatus 100 according to the first embodiment.

The estimation image generation section 126 generates estimation image data 31 through 33 that estimate to which extent the display of an output image can follow as the liquid crystal display 130 decreases the response rate under a low-temperature environment. The estimation image data 31 through 33 include as many frames as the output image data 21 through 23.

Specifically, the estimation image generation section 126 specifies coefficient α indicating a degree to which the liquid crystal display 130 cannot follow a display result. Coefficient α denotes a numeric value between 0 and 1. Coefficient α, when set to 0, signifies 0 as the degree that makes the liquid crystal display 130 unable to follow a display result. Namely, the display can completely follow a display result. In this case, 1/(1−α) corresponds to correction coefficient w in the first embodiment.

Increasing coefficient α increases the degree of correction applied to a residual image. Decreasing coefficient α decreases the degree of correction applied to a residual image and the residual image hardly disappears. Excessively increasing coefficient α generates a residual image whose brightness and darkness are reversed.

The estimation image generation section 126 combines data resulting from multiplying (1−α) by the output image data 22 for the first-previous frame with data resulting from multiplying α by the estimation image data 31 for a second-previous frame, which is a frame previous to the first-previous frame, to generate the estimation image data 32 for the first-previous frame.

To perform the residual image correction, the correction section 122 combines data out of the input image data 11 through 13, namely, combines data for the current frame by increasing an output level with data for the first-previous frame by decreasing an output level of the estimation image data and thereby generates the output image data 23 for the current frame and outputs it as an output image.

Specifically, the correction section 122 multiplies {1/(1−α)} by the input image data 13 for the current frame to increase an output level of the input image data 13, multiplies {1−1/(1−α)} by the estimation image data 32 for the first-previous frame to decrease an output level of the estimation image data 32, and combines both to generate the output image data 23.

Subsequently, the estimation image data for the first-previous frame is likewise generated from the output image data for the first-previous frame and the estimation image data for the second-previous frame. The output image data for the current frame is generated from the input image data for the current frame and the estimation image data for the first-previous frame to continue the residual image correction.

The present embodiment provides the estimation image generation section 126 and uses the estimation image data 31 through 33 to make the more accurate residual image correction available. Coefficient α is used to specifically generate the estimation image data 31 through 33 and perform the residual image correction.

### Third Embodiment

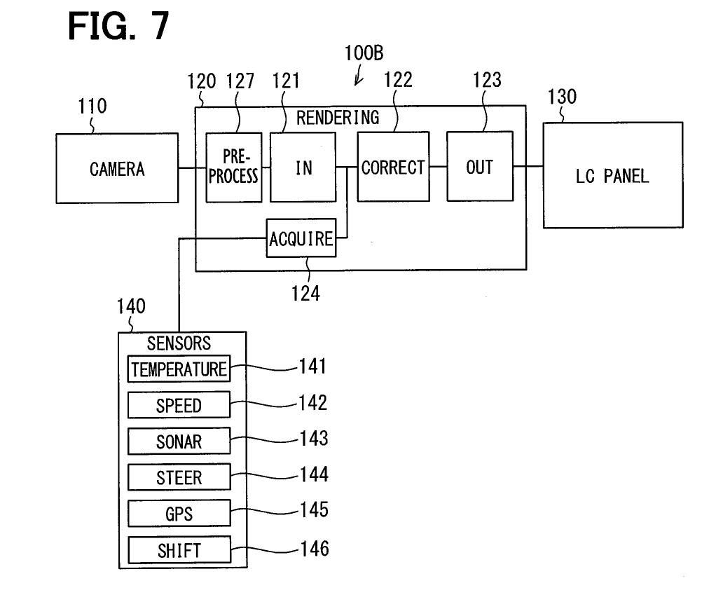

FIG. 7 illustrates a display apparatus 100B according to the third embodiment. The display apparatus 100B according to the third embodiment is provided by adding a preprocessing section 127 to the rendering circuit 120 in the display apparatus 100 according to the first embodiment.

The preprocessing section 127 corrects the image quality in the liquid crystal display 130 before the residual image correction is performed so that the image quality facilitates the residual image correction. The preprocessing section 127 is provided between an output side of the cameras 110 and the input section 121.

The liquid crystal display 130 displays a capture image captured by the cameras 110. In this case, the image quality (color or luminance) may particularly lower the response rate. The residual image correction may not be fully performed if a low response rate is caused by the color or the luminance of images for an oncoming vehicle or an exterior wall as described in the first embodiment, for example. The preprocessing section 127 determines a capture object and explicitly corrects the color or the luminance of the capture object to a color or the luminance whose response rate is high if the color or the luminance of the capture object is characterized by a low response rate.

The preprocessing section 127 provides the image quality easily available to the residual image correction and thereby enables the effective residual image correction to be performed even if the residual image correction is difficult due to the image quality (color or luminance) in the liquid crystal display 130.

### Fourth Embodiment

The correction section 122 according to the above-mentioned embodiments performs the residual image correction and may thereafter perform time correction that resumes the state before performing the residual image correction as the time elapses. After the residual image correction is performed, a noise may occur on an output image correspondingly to the residual image correction performed. An occurrence of the above-mentioned noise can be therefore suppressed by resuming the state before performing the residual image correction as the time elapses after the residual image correction is performed.

### Other Embodiments

The above-mentioned embodiments provide examples of the correction area targets and the contents of setting correction coefficient w corresponding to the travel scenes. However, the embodiments are applicable to the other travel scenes as needed.

The above-mentioned embodiments are described to provide the correction-targeted area, but are not limited thereto. The residual image correction may be always performed on the entire output image without providing the correction-targeted area.

The above-mentioned embodiments use the temperature sensor 141, the vehicle speed sensor 142, the sonar 143, the steering angle sensor 144, the GPS receiver 145, and the shift position sensor 146 as the sensor group 140 to detect a signal corresponding to the traveling state of the vehicle. However, the sensor group 140 is not limited thereto and may use at least one of the sensors 142 and 143.

The sensors 141 through 146 of the sensor group 140 may be replaced by other sensors that can provide comparable detection signals.

The residual image correction in the above-mentioned embodiments can specify correction coefficient w and coefficient α in consideration of the temperature of the liquid crystal display 130. Namely, decreasing the temperature of the liquid crystal display 130 increases the frequency of residual image occurrences. Correction coefficient w and coefficient α may be specified to increase as the temperature decreases.

The above-mentioned embodiments provide the cameras 110 on both lateral surfaces and the rear surface of the vehicle, but are not limited thereto. The respective cameras 110 may be provided on other portions such as the front surface or the top (ceiling) of the vehicle. Basically, the respective cameras 110 can be provided by specifying any positions or directions capable of acquiring images to display surroundings of the vehicle.

While the present disclosure has been described with reference to embodiments thereof, it is to be understood that the disclosure is not limited to the embodiments and constructions. The present disclosure is intended to cover various modification and equivalent arrangements. In addition, the various combinations and configurations, other combinations and configurations, including more, less or only a single element, are also within the spirit and scope of the present disclosure.

What is claimed is:

1. A display apparatus comprising:
a camera that captures surroundings of a vehicle and generates a capture image;
an image processing circuit that is supplied with the capture image as successive image data, performs predetermined image processing, and outputs an output image including display-use image data;
a liquid crystal panel that displays the output image as a motion picture;
a traveling state detector that detects a signal comparable to a traveling state of the vehicle; and
a correction section provided in the image processing circuit, the correction section performing a residual image correction to suppress occurrence of a residual image in the output image due to a decreased response rate of the liquid crystal panel, in accordance with a traveling state of the vehicle acquired by the traveling state detector when a temperature of the liquid crystal panel is lower than a predetermined temperature.

2. The display apparatus according to claim 1,
wherein
the correction section specifies areas targeted at the residual image correction in the capture image and performs the residual image correction by using a correction coefficient assigned specifically to each of the areas.

3. The display apparatus according to claim 2,
wherein
the correction coefficient is determined based on a characteristic of an object in the capture image.

4. The display apparatus according to claim 1,
wherein
the traveling state detector includes at least one of a vehicle speed sensor to detect a vehicle speed signal corresponding to a vehicle speed of the vehicle, a sonar to detect an object signal corresponding to an object around the vehicle, a steering angle sensor to detect a steering angle signal corresponding to a steering angle when the vehicle turns, a receiver to receive a GPS signal acquired by a GPS system, and a shift position sensor to detect a shift signal corresponding to a shift position in a transmission of the vehicle.

5. The display apparatus according to claim 1,
wherein
the image processing circuit includes a preprocessing section that corrects an image quality in the liquid crystal panel before the residual image correction is performed, to facilitate the residual image correction.

6. The display apparatus according to claim 1,
wherein
as a time elapses after the residual image correction is performed, the correction section resumes a state taking place before the residual image correction is performed.

7. The display apparatus according to claim 1,
wherein
the correction section performs the residual image correction by:
specifying a correction coefficient applied to correction corresponding to a traveling state of the vehicle; and
combining,
(i) data resulting from increasing, using the correction coefficient, an output level of an image data of a current frame among the successive image data, and
(ii) data that is obtained by decreasing, using the correction coefficient, an output level of a first-previous frame among the successive image data,
to generate and output the display-use image data corresponding to the current frame as the output image.

8. The display apparatus according to claim 7,
wherein:
the correction coefficient is a numeric value equal to or greater than 1; and
when the correction coefficient is set to w,
the correction section
increases the output level of the image data of the current frame by multiplying w by the image data of the current frame and
decreases the output level of the image data of the first-previous frame by multiplying (1−w) by the image data of the first-previous frame.

9. The display apparatus according to claim 1,
wherein:
the image processing circuit includes an estimation image generation section that generates an estimation image data to estimate to which extent a display follows as the liquid crystal panel decreases the response rate; and
the correction section performs the residual image correction by:
combining
(i) data resulting from increasing an output level of an image data of a current frame among the successive image data, and
(ii) data resulting from decreasing an output level of an estimation image data corresponding to an image data of a first-previous frame among the successive image data,
to generate and output the display-use image data corresponding to the current frame as the output image.

10. The display apparatus according to claim 9,
wherein:
a coefficient that indicates a degree that disables display by the liquid crystal panel from following is set to a ranging from 0 to 1; and
the correction section
increases the output level of the image data of the current frame by multiplying (1/(1−α)) by the image data of the current frame and
decreases the output level of the estimation image data corresponding to the first-previous frame by multiplying {1−1/(1−α)} by the estimation image data corresponding to the first-previous frame.

11. The display apparatus according to claim 10,
wherein
the estimation image generation section generates the estimation image data corresponding to the first-previous frame by combining
(i) data resulting from multiplying (1−α) by the display-use image data corresponding to the first-previous frame and
(ii) data resulting from multiplying α by the estimation image data corresponding to a second-previous frame.
